(19) United States
(12) Patent Application Publication
(10) Pub. No.: US 2025/0272040 A1
(43) Pub. Date: Aug. 28, 2025

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Yusuke TAGUCHI, Kanagawa (JP)

(73) Assignee: FUJIFILM Business Innovation Corp., Tokyo (JP)

(21) Appl. No.: 18/775,294

(22) Filed: Jul. 17, 2024

(30) Foreign Application Priority Data
Feb. 22, 2024 (JP) 2024-025721

(51) Int. Cl. G06F 3/12

(52) U.S. Cl. CPC G06F 3/1273; G06F 3/1222; G06F 3/1253; G06F 3/1288

(57) ABSTRACT

An information processing system includes at least one processor configured to cause a storage unit to store, in association: generated data that is generated based on an input made by a user on an input screen of an information processing apparatus; and input screen data that is a moving image or a plurality of still images showing a record of an input procedure of the user on the input screen.

### CROSS-REFERENCE TO RELATED APPLICATIONS

This application is based on and claims priority under 35 USC 119 from Japanese Patent Application No. 2024-025721 filed Feb. 22, 2024.

### BACKGROUND

### (i) Technical Field

The present disclosure relates to an information processing system, a non-transitory computer readable medium, and an information processing method.

### (ii) Related Art

Japanese Unexamined Patent Application Publication No. 2010-212862 describes a technology for recording, in a database, an operation log based on an operation related to a task performed on an image forming apparatus. In this technology, a process specified in a job received by a receiver is executed based on a task performed on the image forming apparatus. Then, an operation log corresponding to the process in the job is determined and managed in association with the job.

### SUMMARY

Aspects of non-limiting embodiments of the present disclosure relate to storage of an operation log of an information processing apparatus in a form other than text.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including at least one processor configured to cause a storage unit to store, in association: generated data that is generated based on an input made by a user on an input screen of an information processing apparatus; and input screen data that is a moving image or a plurality of still images showing a record of an input procedure of the user on the input screen.

### BRIEF DESCRIPTION OF THE DRAWINGS

Exemplary embodiments of the present disclosure will be described in detail based on the following figures, wherein:

FIG. 1 is a block diagram illustrating an example of an electrical configuration of an information processing system according to an exemplary embodiment;

FIG. 2 is a block diagram illustrating an example of a functional configuration of the information processing system according to the exemplary embodiment;

FIG. 3A is a schematic diagram illustrating an example of printed image data generated in the information processing system according to the exemplary embodiment and original data of the printed image data;

FIG. 3B is a schematic diagram illustrating a state in which the original data and the printed image data are synthesized with input screen data in the information processing system according to the exemplary embodiment;

FIG. 4A is a schematic diagram illustrating an example of a protection process in the information processing system according to the exemplary embodiment;

FIG. 4B is a schematic diagram illustrating another example of the protection process in the information processing system according to the exemplary embodiment;

FIG. 5 is a flowchart illustrating an example of a data generation process in an image forming apparatus;

FIG. 6 is a flowchart illustrating an example of a data storage process in the information processing system according to the exemplary embodiment; and

FIG. 7 is a flowchart illustrating an example of a data processing and transmission process in the information processing system according to the exemplary embodiment.

### DETAILED DESCRIPTION

Hereinafter, an information processing system, a non-transitory computer readable medium, and an information processing method according to an exemplary embodiment of the present disclosure will be described with reference to the drawings. In the drawings, components denoted by the same reference symbols mean that they are the same components. Unless otherwise noted in the specification, each component is not limited to one, and a plurality of components may exist.

Description of the same configurations and reference symbols in the drawings may be omitted. The exemplary embodiment of the present disclosure is not limited to the following exemplary embodiment and any changes such as omission of a configuration, replacement with a different configuration, and combination of the exemplary embodiment and various modifications may be made as appropriate within the scope of the object disclosed herein.

### <Information Processing System>

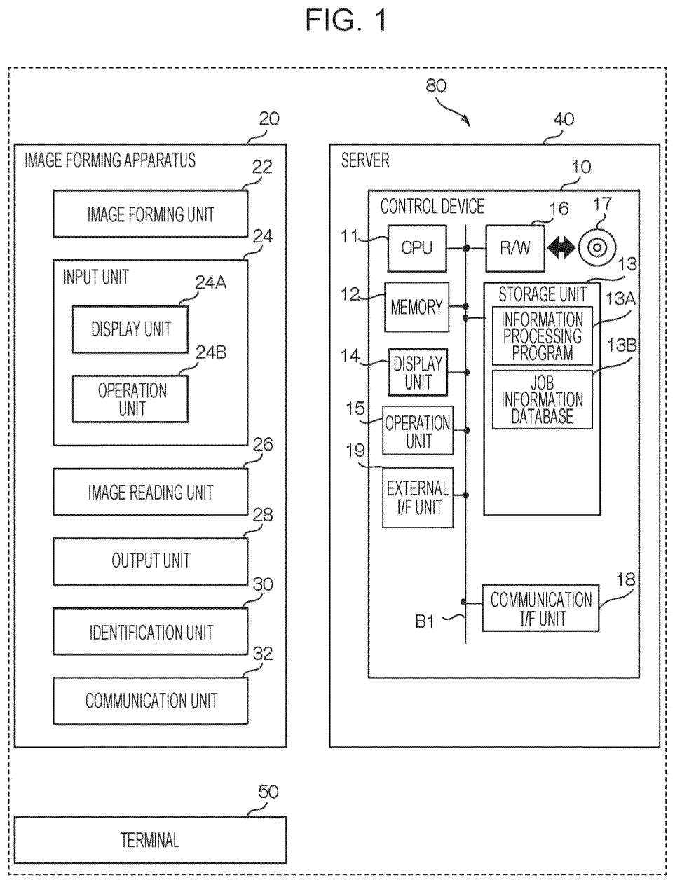

An information processing system 80 illustrated in FIG. 1 is a system constructed in a server 40 configured to communicate with at least one image forming apparatus 20 via a network. The “system” in the exemplary embodiment of the present disclosure includes any of a system constituted by a single apparatus, a system constituted by a plurality of apparatuses, and a system constructed in a higher-level apparatus or system.

That is, the information processing system in the exemplary embodiment of the present disclosure may be constructed over a plurality of apparatuses other than the server 40. For example, the information processing system 80 of this exemplary embodiment may be constructed by including the image forming apparatus 20.

Various processes to be executed by the information processing system 80 may be executed by a cloud, an on-premises server, an edge server, an endpoint, etc.

As described in detail later, the information processing system 80 may record an operation log of the image forming apparatus 20 in a form other than text, and manage printed image data of a printed matter generated based on the operation and the operation log in association with each other. The printed image data is an example of generated data in the exemplary embodiment of the present disclosure.

The information processing system 80 may transmit, to a terminal 50 connected via the network, the printed image data and the operation log that are visually recognizable by a user of the terminal 50.

Examples of the terminal 50 include a personal terminal that is used by an operator accessible to a user of the image forming apparatus 20 via a network, a telephone, etc. The terminal 50 that may communicate with the information processing system 80 is determined in advance.

### <Image Forming Apparatus>

The image forming apparatus 20 of this exemplary embodiment is an example of an information processing apparatus in the exemplary embodiment of the present disclosure. The image forming apparatus 20 receives a job in response to an input operation of a user and executes the specified job. Examples of the job to be executed by the image forming apparatus 20 include a print job for forming a document image generated from a read document etc. on a recording medium such as paper.

The document to be read by the image forming apparatus 20 may be a document set on an image reading unit 26 described later or a document acquired from the network via a communication unit 32 described later.

The image forming apparatus 20 includes an image forming unit 22, an input unit 24, the image reading unit 26, an output unit 28, an identification unit 30, and the communication unit 32. The image forming apparatus 20 includes a central processing unit (CPU: processor), and various processes to be executed by the image forming apparatus 20 are executed by the CPU.

### (Image Forming Unit)

The image forming unit 22 forms a document image generated by the image reading unit 26 (not illustrated) on a recording medium such as paper by using, for example, an electrophotographic system or an inkjet recording system.

### (Input Unit)

The input unit 24 is an interface through which a user may input a job to be executed by the image forming apparatus 20, and includes a display unit 24A and an operation unit 24B.

The display unit 24A is a display screen that is a combination of, for example, a touch panel and a liquid crystal display or an organic EL display. The display unit 24A displays an image etc. in response to a user's touch operation, processing by the image forming apparatus 20, etc. The operation unit 24B includes operation keys, operation buttons, a power button, etc. on the image forming apparatus 20.

A user may specify details of a job or input a job execution instruction on the image forming apparatus 20 by a touch operation on the display unit 24A. Part of the user's input operation may be performed via the operation unit 24B. The information input via the input unit 24 may be referred to collectively as “input information” in the following description.

### (Image Reading Unit)

The image reading unit 26 includes a charge-coupled device (CCD) image sensor etc. that reads a document set on a paper table (not illustrated) of the image forming apparatus 20 and generates a document image.

Examples of the paper table include a paper tray provided to a duplexing auto document feeder (DADF) mounted at the upper end of the image forming apparatus 20. The paper table may be a manual paper tray provided at the side of the image forming apparatus 20.

### (Output Unit)

The output unit 28 includes a paper output tray provided at the side of the image forming apparatus 20. An output product on which a document image is formed by the image forming unit 22 is output to the paper output tray. The output unit 28 may include one paper output tray alone or a plurality of paper output trays.

### (Identification Unit)

The identification unit 30 is a reading device that reads a user ID. The user ID is personal identification information uniquely assigned to each user as an identifier for identifying the user who uses the image forming apparatus 20.

The user ID may be read from a card in which the user ID is stored. The user ID may be input by operating the input unit 24. After the user ID is read and the user logs into the image forming apparatus 20, the user may give an instruction to execute a desired job and log out via, for example, the input unit 24.

### (Communication Unit)

The communication unit 32 is an interface for communicably connecting, via the network, the image forming apparatus 20 to the server 40 provided outside the image forming apparatus 20 and various terminals that are used by users.

The communication unit 32 transmits information acquired by the image forming apparatus 20 and information generated by the image forming apparatus 20 to the server 40. The communication unit 32 may acquire “original data” serving as a document of a printed matter from the network. The original data acquired from the network is stored in a memory of the image forming apparatus 20.

### <Server>

The server 40 has a configuration similar to that of a general computer and includes a control device 10.

### (Control Device)

As described in detail later, the control device 10 records an operation log of at least one image forming apparatus 20 connected via the network in a form other than text, and manages printed image data of a printed matter generated based on the operation and the operation log in association with each other.

### (Electrical Configuration of Control Device)

The control device 10 includes a CPU 11, a memory 12 serving as a temporary storage area, a nonvolatile storage unit 13, an input unit 14, a display unit 15 such as a liquid crystal display, a medium reading and writing device (R/W) 16, a communication interface (I/F) unit 18, and an external I/F unit 19. The CPU 11, the memory 12, the storage unit 13, the input unit 14, the display unit 15, the medium reading and writing device 16, the communication I/F unit 18, and the external I/F unit 19 are connected to each other via a bus B1.

The CPU 11 controls the overall operation of the control device 10. The medium reading and writing device 16 reads information written in a recording medium 17 and writes information into the recording medium 17. The communication I/F unit 18 is an interface for communicably connecting the control device 10 to, for example, a server provided outside the control device and various terminals that are used by users. The communication I/F unit 18 uses, for example, communication standards such as Wi-Fi (registered trademark), Bluetooth (registered trademark), and a local area network (LAN).

### (Storage Unit)

The storage unit 13 is implemented by a hard disk drive (HDD), a solid state drive (SSD), a flash memory, etc. The storage unit 13 serving as a storage medium stores an information processing program 13A. The information processing program 13A is stored in the storage unit 13 in such a manner that the recording medium 17 in which the information processing program 13A is written is set in the medium reading and writing device 16 and the medium reading and writing device 16 reads the information processing program 13A from the recording medium 17. The CPU 11 reads the information processing program 13A from the storage unit 13, loads the information processing program 13A in the memory 12, and sequentially executes processes in the information processing program 13A. The storage unit 13 stores a job information database 13B described later.

### (Input Unit)

The input unit 14 is used to input various types of information. In one example, the input unit 14 is operated by an administrator of the information processing system to start and terminate the information processing program 13A.

### (Display Unit)

The display unit 15 is used to display various types of information. In one example, the display unit 15 displays information to start and terminate the information processing program 13A.

### (Functional Configuration of Control Device)

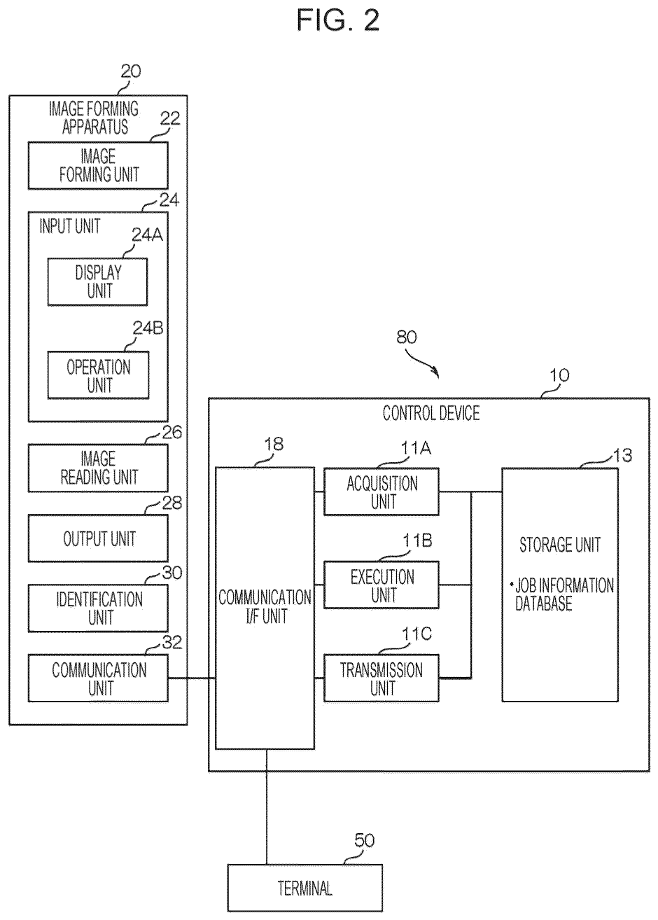

Next, a functional configuration of the control device 10 according to this exemplary embodiment will be described with reference to FIG. 2. As illustrated in FIG. 2, the control device 10 includes an acquisition unit 11A, an execution unit 11B, and a transmission unit 11C. The CPU 11 of the control device 10 functions as the acquisition unit 11A, the execution unit 11B, and the transmission unit 11C by executing the information processing program 13A.

### (Acquisition Unit)

### Acquisition of Image Data

The acquisition unit 11A acquires, from the image forming apparatus 20, “printed image data” of a printed matter generated based on an input made by a user on the input unit 24 (specifically, the display unit 24A that is an input screen) of the image forming apparatus 20.

The acquisition unit 11A also acquires image data that is “original data” for the printed image data from the image forming apparatus 20.

The “original data” is document data of the printed image data and, in one example, is generated by the image reading unit 26 of the image forming apparatus 20 in response to a user's instruction to execute a print job via the input unit 24 of the image forming apparatus 20. Examples of the original data include document data generated at the time of copying.

The “original data” may be document data generated by a user with a personal terminal and acquired by the communication unit 32 from the network. Examples of the original data include document data for printing.

The “printed image data” is product data indicating the appearance of a printed matter generated from the “original data”.

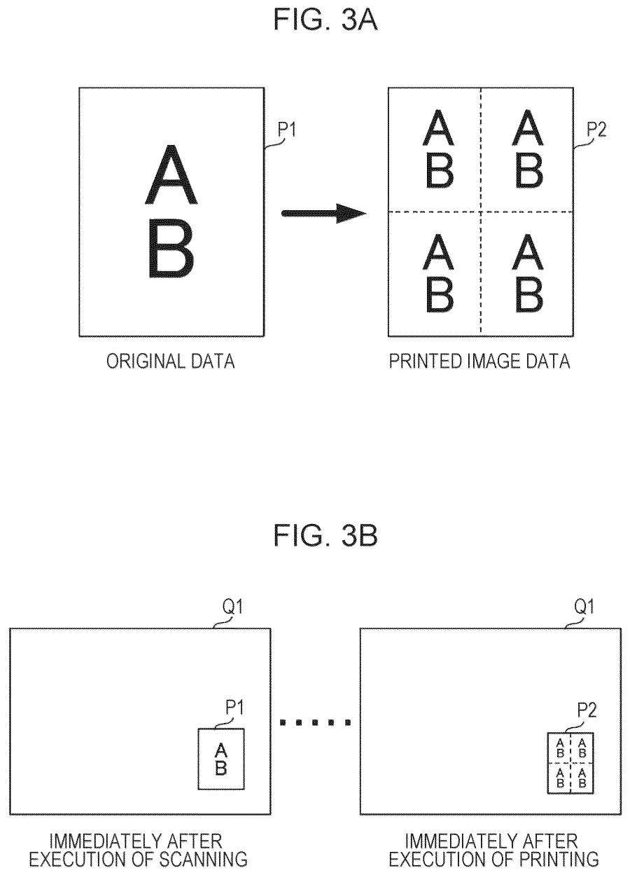

In one example, as illustrated in FIG. 3A, a user gives, via the input unit 24, an instruction to execute “4-up printing” on original data P1 of a document in which an image A and an image B are arranged one above the other. In this case, printed image data P2 is obtained by laying out four sets of the reduced original data P1 on paper.

### Acquisition of Input Screen Data

The acquisition unit 11A acquires an operation log from the image forming apparatus 20. Specifically, the acquisition unit 11A acquires “input screen data” as an operation log from the image forming apparatus 20. The input screen data is a moving image or a plurality of still images showing a record of a user's input procedure on the input unit 24 of the image forming apparatus 20.

In the “input screen data”, for example, an input procedure for the user's instruction to execute the “4-up printing” is recorded.

The input screen data that is a “moving image” is obtained by recording transition of the display screen of the input unit 24 as a moving image. The input screen data may be processed so that a portion touched by the user can be visually recognized. Examples of the processing include a process of changing the color of the touched portion over a touching period.

The input screen data that is a “plurality of still images” is obtained by recording transition of the display screen of the input unit 24 as a plurality of still images. The plurality of still images is stored for the individual screens touched by the user. The input screen data may be processed so that a portion touched by the user can be visually recognized.

In a case where the input screen data is generated as a plurality of still images and the input screen is scrolled in a print instruction via the input unit 24, information indicating that the input screen has been scrolled is acquired as part of the input screen data.

In one example, the “information indicating that the input screen has been scrolled” includes still images of input screens before and after scrolling, and pieces of tagging information indicating “before scrolling” and “after scrolling” assigned to the still images.

The generation of the input screen data by the image forming apparatus 20 starts in response to input of information to the input unit 24 after the identification unit 30 reads the user ID, and ends in response to logout of the user. The storage unit 13 of the control device 10 in the server 40 stores the “printed image data”, the “original data”, and the “input screen data” in association with each other for each job.

In a case where the user inputs a plurality of jobs, input screen data may be generated for each job. Specifically, the generation of first input screen data starts in response to reading of the user ID by the identification unit 30, and ends in response to completion of execution of the first job.

The generation of second input screen data starts in response to a new input operation other than logout, and ends in response to completion of execution of the second job. When the user logs out before a new operation is input, new input screen data is not generated.

In the case where a plurality of jobs is input to the image forming apparatus 20, the acquisition unit 11A acquires “printed image data”, “original data”, and “input screen data” for each job. The storage unit 13 stores the “printed image data”, the “original data”, and the “input screen data” in association with each other for each job.

### Acquisition of Personal Identification Information

The acquisition unit 11A acquires a user ID that is personal identification information when the identification unit 30 of the image forming apparatus 20 reads the user ID. The storage unit 13 stores the “printed image data”, the “original data”, the “input screen data”, and the “user ID” in association with each other for each job.

The acquisition unit 11A acquires, in addition to the user ID, “login information” indicating that the user has logged into the image forming apparatus 20. The acquisition unit 11A acquires “logout information” indicating that the user has logged out of the image forming apparatus 20.

### Acquisition of Transmission Request

The acquisition unit 11A acquires a “transmission request” for “printed image data”, “original data”, and “input screen data” from a predetermined terminal 50.

### (Execution Unit)

### Execution of Image Synthesis

When the acquisition unit 11A acquires the transmission request, the execution unit 11B synthesizes original data and printed image data with input screen data that is a “moving image” acquired by the acquisition unit 11A.

As an example of the synthesis method, as illustrated in FIG. 3B, the execution unit 11B synthesizes, in input screen data Q1, the original data P1 with a portion immediately after scanning of the document is executed in response to a printing execution instruction from the user. The execution unit 11B synthesizes, in the input screen data Q1, the printed image data P2 with a portion immediately after the document is printed.

The execution unit 11B may be configured to synthesize the printed image data with the input screen data that is the “moving image” acquired by the acquisition unit 11A, and not to synthesize the original data with the input screen data. In this case, the acquisition unit 11A need not acquire the original data.

The execution unit 11B may be configured to synthesize neither of the original data and the printed image data with the input screen data that is the “moving image” acquired by the acquisition unit 11A.

Regarding a job in which the acquisition unit 11A has acquired input screen data that is “still images” but has not acquired input screen data that is a “moving image”, the execution unit 11B does not synthesize original data and printed image data with the input screen data.

### Execution of Protection Process

The execution unit 11B executes a “protection process” for preventing visual recognition of protective information in printed image data. The “protective information” is information that is not desired to be known to users other than the user who has given an instruction to execute a print job, such as personal information of the user.

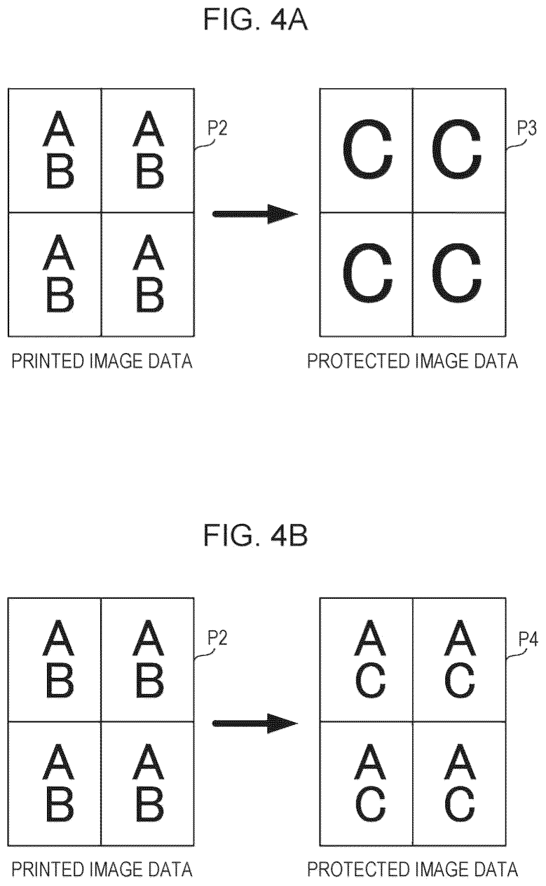

For example, when the image B in the original data P1 illustrated in FIG. 3A includes protective information, the execution unit 11B generates protected image data P3 illustrated in FIG. 4A as an example of the protection process. The protected image data P3 is image data obtained by replacing each “original data portion” in the printed image data P2 with a substitute image C.

As another example of the protection process, the execution unit 11B may generate protected image data P4 illustrated in FIG. 4B. The protected image data P4 is image data obtained by replacing each “image B in protective area” in the printed image data P2 with the substitute image C. That is, the execution unit 11B replaces only the protective area in the original data with the substitute image C.

At this time, the execution unit 11B identifies, as the protective area, a portion including the protective information (image B) in the original data. The execution unit 11B identifies the protective area by executing an optical character recognition (OCR) process and a determination program on the original data.

The determination program is a program for determining whether protective information is included in text information and for identifying a portion including the protective information, and is stored in the storage unit 13.

As another example of the protection process, the execution unit 11B does not transmit the original data to the terminal 50 in addition to the above protection process. In a case where the original data is transmitted to the terminal 50, the execution unit 11B executes a process of replacing the original data to be transmitted with the substitute image C or replacing the protective area with the substitute image C.

The user may give an instruction to execute the protection process via the input unit 24 of the image forming apparatus 20. The instruction to execute the protection process need not be given at the same time as the instruction to execute the job. After the instruction to execute the job is given, the user may specify, via the input unit 24, a job for which the protection process is to be executed later (hereinafter sometimes referred to as “protection process request”).

In this case, the protection process request is acquired by the acquisition unit 11A and stored in the job information database 13B in association with the data group in which the “printed image data”, the “original data”, the “input screen data”, and the “user ID” are associated with each other.

### Execution of Storage Amount Limitation

The execution unit 11B executes “storage amount limitation” for limiting the recording amount of a data group including printed image data, original data, and input screen data.

In one example of the storage amount limitation, the execution unit 11B deletes a data group of a job after a predetermined storage period has elapsed since the input of the job. Any storage period may be set by the administrator.

As another example of the storage amount limitation, the execution unit 11B deletes a data group of the oldest job after the total data amount of datasets has exceeded a predetermined capacity. Any capacity may be set by the administrator.

### Execution of Image Synthesis

When the acquisition unit 11A acquires the transmission request, the execution unit 11B synthesizes original data and printed image data with input screen data that is a “moving image” acquired by the acquisition unit 11A.

As an example of the synthesis method, as illustrated in FIG. 3B, the execution unit 11B synthesizes, in the input screen data Q1, the original data P1 with a portion immediately after scanning of the document is executed in response to a printing execution instruction from the user. The execution unit 11B synthesizes, in the input screen data Q1, the printed image data P2 with a portion immediately after the document is printed.

The execution unit 11B may be configured to synthesize the printed image data with the input screen data that is the “moving image” acquired by the acquisition unit 11A, and not to synthesize the original data with the input screen data. In this case, the acquisition unit 11A need not acquire the original data.

The execution unit 11B may be configured to synthesize neither of the original data and the printed image data with the input screen data that is the “moving image” acquired by the acquisition unit 11A.

Regarding a job in which the acquisition unit 11A has acquired input screen data that is “still images” but has not acquired input screen data that is a “moving image”, the execution unit 11B does not synthesize original data and printed image data with the input screen data.

### (Transmission Unit)

The transmission unit 11C transmits, to the terminal 50, input screen data that is a “moving image” generated in the execution unit 11B by synthesizing original data and printed image data.

Alternatively, the transmission unit 11C may transmit, to the terminal 50, input screen data that is a “moving image” generated in the execution unit 11B by synthesizing printed image data. At this time, the transmission unit 11C may or may not transmit original data separately from the input screen data.

Alternatively, the transmission unit 11C may transmit, to the terminal 50, input screen data that is a “moving image” acquired by the acquisition unit 11A and printed image data separate from the input screen data. At this time, the transmission unit 11C may or may not transmit original data.

Alternatively, the transmission unit 11C may transmit, to the terminal 50, input screen data that is “still images” and printed image data acquired by the acquisition unit 11A. At this time, the transmission unit 11C may or may not transmit original data.

### <Data Generation Process>

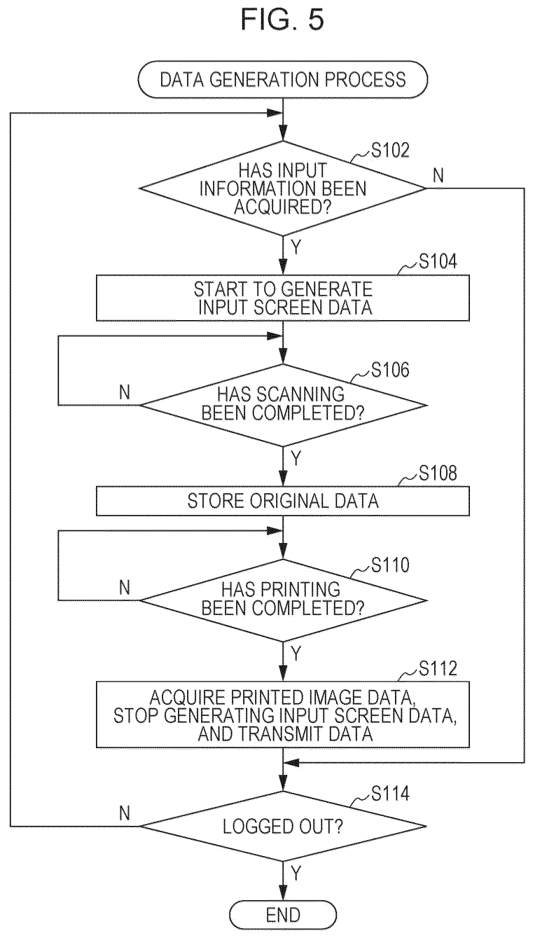

The CPU of the image forming apparatus 20 executes a “data generation process” illustrated in FIG. 5 when the identification unit 30 of the image forming apparatus 20 reads a user ID that is personal identification information.

When the data generation process is executed, the CPU of the image forming apparatus 20 (hereinafter referred to as “CPU”) waits for acquisition of input information in step S102. When the CPU has acquired input information, the process proceeds to step S104. When the CPU has not acquired input information, the process proceeds to step S114.

In step S104, the CPU starts to generate input screen data. Specifically, the CPU starts to record a moving image or a plurality of still images on the display unit 24A of the input unit 24. After step S104, the process proceeds to step S106.

In step S106, the CPU waits for scanning of a document by the image reading unit 26. When the scanning is completed, the process proceeds to step S108, and original data (document data of printed image data) generated from the scanned image is stored. After step S108, the process proceeds to step S110.

In step S110, the CPU waits for completion of a print job by the output unit 28. When the print job is completed, the process proceeds to step S112.

In step S112, the CPU acquires printed image data. The CPU stops generating the input screen data. The CPU transmits the original data, the printed image data, and the input screen data to the server 40. After step S112, the process proceeds to step S114.

In step S114, the CPU determines whether logout information has been acquired. When affirmative determination is made in step S114, the data generation process is terminated. When negative determination is made in step S114, the process returns to step S102.

### <Data Storage Process>

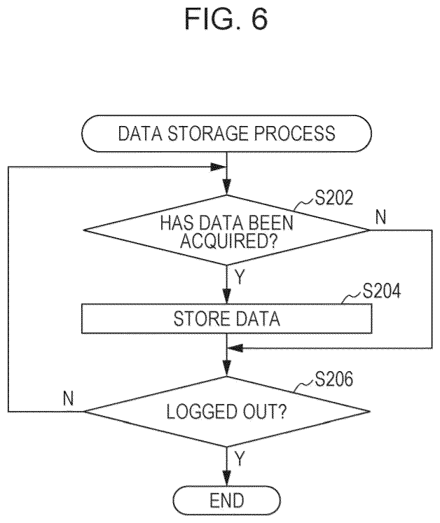

The CPU 11 of the control device 10 in the server 40 starts a “data storage process” illustrated in FIG. 6 in response to acquisition of login information of a user from the image forming apparatus 20.

When the data storage process is executed, the CPU 11 determines, in step S202, whether original data, printed image data, and input screen data have been acquired from the image forming apparatus 20. When affirmative determination is made in step S202, the process proceeds to step S204. When negative determination is made in step S202, the process proceeds to step S206.

In step S204, the CPU 11 stores the original data, the printed image data, the input screen data, and the user ID acquired from the image forming apparatus 20 in association with each other. After step S204, the process proceeds to step S206.

In step S206, the CPU 11 determines whether logout information has been acquired from the image forming apparatus 20. When affirmative determination is made in step S206, the data storage process is terminated. When negative determination is made in step S206, the process returns to step S202.

### <Data Processing and Transmission Process>

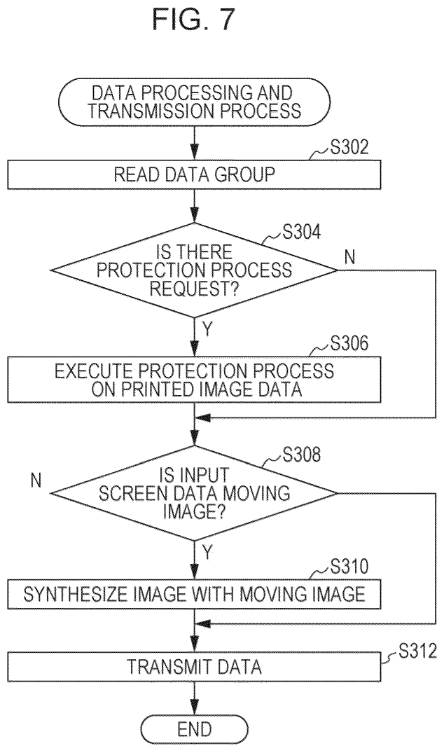

The CPU 11 of the control device 10 in the server 40 starts a “data processing and transmission process” illustrated in FIG. 7 in response to acquisition of a transmission request from the terminal 50.

When the data processing and transmission process is executed, in step S302, the CPU 11 reads, from the storage unit 13, a data group (original data, printed image data, input screen data, and user ID) of a job for which the transmission request has been made. After step S302, the process proceeds to step S304.

In step S304, the CPU 11 determines whether a protection process request is associated with the data group of the job for which the transmission request has been made. When affirmative determination is made in step S304, the process proceeds to step S306. When negative determination is made in step S304, the process proceeds to step S308.

In step S306, the CPU 11 executes the protection process on the acquired printed image data to generate protected image data. After step S306, the process proceeds to step S308.

In step S308, the CPU 11 determines whether the acquired input screen data is a moving image. When affirmative determination is made in step S308, the process proceeds to step S310. When negative determination is made in step S308, that is, when the input screen data is still images, the process proceeds to step S312.

In step S310, the CPU 11 synthesizes the original data and the printed image data with the input screen data. When affirmative determination is made in step S304, the protected image data instead of the printed image data is synthesized with the input screen data, and the original data is not synthesized with the input screen data. After step S310, the process proceeds to step S312.

In step S312, the CPU 11 transmits the data to the terminal 50. When affirmative determination is made in step S304 and affirmative determination is made in step S308, the input screen data that is the moving image synthesized with the protected image data is transmitted to the terminal 50. When affirmative determination is made in step S304 and negative determination is made in step S308, the protected image data and the input screen data that is the still images are transmitted to the terminal 50. When negative determination is made in step S304 and affirmative determination is made in step S308, the input screen data that is the moving image synthesized with the original data and the printed image data is transmitted to the terminal 50. When negative determination is made in step S304 and negative determination is made in step S308, the original data, the printed image data, and the input screen data that is the still images are transmitted to the terminal 50. After the data is transmitted, the data processing and transmission process is terminated.

### <Interrelationship of Processes>

When the user of the image forming apparatus 20 gives an instruction to execute a print job, the “data generation process” illustrated in FIG. 5 is executed by the image forming apparatus 20. In conjunction with the data generation process, the “data storage process” illustrated in FIG. 6 is executed by the control device 10 of the server 40.

When the output printed matter is different from an intended printed matter, for example, when 4-up printing is executed though 2-up printing is intended, the user of the image forming apparatus 20 may send an inquiry to an operator.

When protective information is included in the printed matter, the user may give a protection process instruction via the image forming apparatus 20 prior to the inquiry to the operator.

When the inquiry is received, the operator operates the terminal 50 to give a transmission request to the server 40 to transmit data of the job for which the inquiry has been received. Thus, the “data processing and transmission process” illustrated in FIG. 7 is executed.

By checking input screen data that is a moving image or still images acquired by the terminal 50, the operator may grasp what has been input to the input unit 24 by the user of the image forming apparatus 20. Thus, the user of the image forming apparatus 20 may be informed of the reason why the output printed matter is different from the intended printed matter.

### <Operations and Advantages>

In the information processing system 80 according to the exemplary embodiment of the present disclosure, printed image data of a printed matter generated based on user's input on the input unit 24 (display unit 24A) of the image forming apparatus 20 and input screen data that is a moving image or a plurality of still images showing a record of a user's input procedure on the input unit 24 are stored in the storage unit 13 in association with each other.

In this way, in the information processing system 80, the operation log of the image forming apparatus may be recorded in a form other than text (i.e., a moving image or a plurality of still images).

In the information processing system 80 according to the exemplary embodiment of the present disclosure, when the input screen data acquired from the image forming apparatus 20 is a moving image, the printed image data is synthesized with the acquired moving image. Compared to a case where the printed image data is not synthesized with the moving image, the load of data recording may be reduced and the memory consumption of the storage unit 13 may be reduced. Further, the amount of data transmitted to the terminal 50 may be reduced.

In the information processing system 80 according to the exemplary embodiment of the present disclosure, when the input screen data acquired from the image forming apparatus 20 is a plurality of still images and the display unit 24A has been scrolled in a print instruction, information indicating that the input screen has been scrolled is stored in the storage unit 13 as part of the input screen data. Thus, the operator may grasp details of operation more easily than in a case of only the operation record that is still images.

In the information processing system 80 according to the exemplary embodiment of the present disclosure, personal identification information of an instructing user who has given the print instruction is further acquired and stored. Thus, the operation records may be classified for individual users.

In the information processing system 80 according to the exemplary embodiment of the present disclosure, the protection process for preventing visual recognition of protective information in the printed image data is executed. Thus, users other than the instructing user who has given the print instruction, such as the operator of the terminal 50, no longer view the protective information.

In the information processing system 80, as illustrated in FIG. 4A, the original data in the printed image data may be replaced with substitute image data as the protection process. Thus, the protection process may be simplified compared to the case where the portion including the protective information is identified as the protective area as illustrated in FIG. 4B.

In the information processing system 80, as illustrated in FIG. 4B, the portion including the protective information may be identified as the protective area, and the protective area may be replaced with the substitute image data. In this case, the area other than the protective area may be reproduced in the printed image data similarly to the original data.

In the information processing system 80 according to the exemplary embodiment of the present disclosure, the recording amount of the data group including the original data, the printed image data, and the input screen data is limited. Compared to a case where the recording amount is not limited, the load of data recording may be reduced.

In the information processing system 80 according to the exemplary embodiment of the present disclosure, when a plurality of print jobs is input to the image forming apparatus 20, the original data, the printed image data, and the input screen data are stored in association with each other for each of the print jobs. Thus, the relationship between the input operation and the print result may be grasped more easily than in a case where input screen data obtained by collectively recording pieces of input screen data of the plurality of print jobs is associated with the pieces of printed image data of the individual jobs.

In the information processing system 80 according to the exemplary embodiment of the present disclosure, the original data of the printed image data is stored in association with the printed image data, and the original data is transmitted in response to a transmission request from the terminal 50. Thus, the operator of the terminal 50 who has transmitted the transmission request may compare the original data with the printed image data.

### OTHER EXEMPLARY EMBODIMENTS

In the above exemplary embodiment, the image forming apparatus 20 is used as the information processing apparatus, and the printed image data of the printed matter is used as the generated data, but the exemplary embodiment of the present disclosure is not limited thereto. For example, a smartphone or a tablet terminal carried by a user may be used as the information processing apparatus.

In this case, examples of the generated data that is generated based on the user's input on the input screen of the information processing apparatus include various types of setting data for the smartphone and various types of data generated using an application installed in the smartphone.

The information processing apparatus may be the image forming apparatus 20 or a home appliance that uses a smartphone etc. as an input screen. That is, the information processing apparatus according to the exemplary embodiment of the present disclosure may be a smartphone itself or various devices to be operated using the smartphone.

In the above exemplary embodiment, the acquisition unit 11A acquires information indicating that the input screen has been scrolled when the input screen data includes a plurality of still images, but the exemplary embodiment of the present disclosure is not limited thereto. Such information need not be generated or acquired.

In the above exemplary embodiment, the acquisition unit 11A acquires personal identification information of an instructing user who has given a print instruction, but the exemplary embodiment of the present disclosure is not limited thereto. Even if the personal identification information is not acquired, the user may send an inquiry to the operator using a job ID etc. individually assigned to each print job.

In the above exemplary embodiment, the execution unit 11B executes the protection process for preventing visual recognition of the protective information in the printed image data, but the exemplary embodiment of the present disclosure is not limited thereto. Such a protection process need not be executed.

In the above exemplary embodiment, the execution unit 11B limits the recording amount of the data group including the printed image data and the input screen data, but the exemplary embodiment of the present disclosure is not limited thereto. Such limitation need not be executed.

In the above exemplary embodiment, when a plurality of print jobs is input to the image forming apparatus 20, input screen data is generated for each of the print jobs, and the printed image data and the input screen data are stored in association with each other, but the exemplary embodiment of the present disclosure is not limited thereto. For example, the pieces of input screen data of the plurality of print jobs may be generated collectively.

Also in the above various exemplary embodiments, when the user's operation log of the image forming apparatus 20 is recorded in a form other than text, the operator of the terminal 50 may grasp details of operation more easily than in the case where the operation log is recorded in text.

In the above exemplary embodiment, the transmission unit 11C transmits the input screen data and the printed image data to the terminal 50, but the exemplary embodiment of the present disclosure is not limited thereto. Each piece of data stored in the storage unit 13 may be written into and acquired from a recording medium instead of being transmitted by the transmission unit 11C.

In the above exemplary embodiment, various processors described below may be used as a hardware structure of a processing unit that executes the processes of, for example, the acquisition unit 11A, the execution unit 11B, and the transmission unit 11C. Examples of the various processors include, as described above, a CPU that is a general-purpose processor that functions as the processing unit by executing software (program), a programmable logic device (PLD) that is a processor whose circuit configuration may be changed after manufacturing, such as a field-programmable gate array (FPGA), and a dedicated electric circuit that is a processor having a circuit configuration designed exclusively for executing specific processes, such as an application specific integrated circuit (ASIC).

The processing unit may be constituted by one of these various processors, or may be constituted by a combination of two or more processors of the same type or different types (e.g., a combination of a plurality of FPGAs or a combination of a CPU and an FPGA). The processing unit may be constituted by one processor. Part or all of these processors may be configured on a cloud. At least each process described in the above exemplary embodiment may be executed by a processor on a cloud.

As a first example of the processing unit constituted by one processor, one processor is configured by a combination of one or more CPUs and software and this processor functions as the processing unit, as typified by computers such as a client and a server. As a second example, a processor that implements the functions of the entire system including the processing unit by one integrated circuit (IC) chip is used, as typified by a system on chip (SoC). In this way, the processing unit is constituted by one or more of the various processors as the hardware structure.

More specifically, the hardware structure of each of these various processors may use electric circuitry that is a combination of circuit elements such as semiconductor elements. As described above, the exemplary embodiment of the present disclosure may be implemented in various ways.

### APPENDIX

(((1)))

An information processing system comprising at least one processor configured to cause a storage unit to store, in association:
generated data that is generated based on an input made by a user on an input screen of an information processing apparatus; and
input screen data that is a moving image or a plurality of still images showing a record of an input procedure of the user on the input screen.
   (((2)))

The information processing system according to (((1))), wherein:
the information processing apparatus is an image forming apparatus;
the generated data is printed image data of a printed matter; and the processor is configured to transmit the acquired input screen data and the acquired printed image data in response to reception of a transmission request for the input screen data and the printed image data from a predetermined terminal.
   (((3)))

The information processing system according to (((2))), wherein:
the input screen data is the moving image; and
the processor is configured to, in response to the reception of the transmission request, synthesize the printed image data with the acquired moving image and transmit the moving image.
   (((4)))

The information processing system according to (((2))), wherein:
the input screen data includes the plurality of still images; and
the processor is configured to, when the input screen has been scrolled in a print instruction, further cause the storage unit to store, as part of the input screen data, information indicating that the input screen has been scrolled.
   (((5)))

The information processing system according to any one of (((2))) to (((4))), wherein the processor is configured to further acquire personal identification information of an instructing user who has given a print instruction.

(((6))

The information processing system according to any one of (((2))) to (((5))), wherein the processor is configured to execute a protection process for preventing visual recognition of protective information in the printed image data.

(((7)))

The information processing system according to (((6))), wherein the processor is configured to, as the protection process, replace original data in the printed image data with substitute image data.

(((8)))

The information processing system according to (((6))), wherein the processor is configured to, as the protection process:
identify a portion including the protective information in original data as a protective area; and
replace the protective area in the printed image data with substitute image data.
   (((9)))

The information processing system according to any one of (((2))) to (((8))), wherein the processor is configured to limit a recording amount of a data group including the printed image data and the input screen data.

(((10)))

The information processing system according to any one of (((2))) to (((8))), wherein the processor is configured to, when a plurality of print jobs is input to the image forming apparatus, store the printed image data and the input screen data in association with each other for each of the print jobs.

(((11)))

The information processing system according to (((3))), wherein the processor is configured to:
store original data of the printed image data in association with the printed image data; and
transmit the original data in response to the transmission request.
   (((12)))

A program causing a computer to execute a process for processing information, the process comprising causing a storage unit to store, in association:
generated data that is generated based on an input made by a user on an input screen of an information processing apparatus; and
input screen data that is a moving image or a plurality of still images showing a record of an input procedure of the user on the input screen.
   (((13)))

An information processing method comprising:
generating generated data based on an input made by a user on an input screen of an information processing apparatus; and
causing a storage unit to store, in association, the generated data and input screen data that is a moving image or a plurality of still images showing a record of an input procedure of the user on the input screen.

What is claimed is:

1. An information processing system comprising:
at least one processor configured to cause a storage unit to store, in association:
generated data that is generated based on an input made by a user on an input screen of an information processing apparatus; and
input screen data that is a moving image or a plurality of still images showing a record of an input procedure of the user on the input screen.

2. The information processing system according to claim 1, wherein:
the information processing apparatus is an image forming apparatus;
the generated data is printed image data of a printed matter; and
the processor is configured to transmit the acquired input screen data and the acquired printed image data in response to reception of a transmission request for the input screen data and the printed image data from a predetermined terminal.

3. The information processing system according to claim 2, wherein:
the input screen data is the moving image; and
the processor is configured to, in response to the reception of the transmission request, synthesize the printed image data with the acquired moving image and transmit the moving image.

4. The information processing system according to claim 2, wherein:
the input screen data includes the plurality of still images; and
the processor is configured to, when the input screen has been scrolled in a print instruction, further cause the storage unit to store, as part of the input screen data, information indicating that the input screen has been scrolled.

5. The information processing system according to claim 2, wherein the processor is configured to further acquire personal identification information of an instructing user who has given a print instruction.

6. The information processing system according to claim 2, wherein the processor is configured to execute a protection process for preventing visual recognition of protective information in the printed image data.

7. The information processing system according to claim 6, wherein the processor is configured to, as the protection process, replace original data in the printed image data with substitute image data.

8. The information processing system according to claim 6, wherein the processor is configured to, as the protection process:
identify a portion including the protective information in original data as a protective area; and
replace the protective area in the printed image data with substitute image data.

9. The information processing system according to claim 2, wherein the processor is configured to limit a recording amount of a data group including the printed image data and the input screen data.

10. The information processing system according to claim 2, wherein the processor is configured to, when a plurality of print jobs is input to the image forming apparatus, store the printed image data and the input screen data in association with each other for each of the print jobs.

11. The information processing system according to claim 3, wherein the processor is configured to:
store original data of the printed image data in association with the printed image data; and
transmit the original data in response to the transmission request.

12. A non-transitory computer readable medium storing a program causing a computer to execute a process for processing information, the process comprising causing a storage unit to store, in association:
generated data that is generated based on an input made by a user on an input screen of an information processing apparatus; and
input screen data that is a moving image or a plurality of still images showing a record of an input procedure of the user on the input screen.

13. An information processing method comprising:
generating generated data based on an input made by a user on an input screen of an information processing apparatus; and
causing a storage unit to store, in association, the generated data and input screen data that is a moving image or a plurality of still images showing a record of an input procedure of the user on the input screen.
